(19) United States
(12) Patent Application Publication
(10) Pub. No.: US 2004/0173178 A1
(43) Pub. Date: Sep. 9, 2004

(54) Intake air filter

(75) Inventors: Heinz Hettmann, Schorndorf (DE); Sebastian Friedrich, Waiblingen (DE)

Correspondence Address: ROBERT W. BECKER & ASSOCIATES, Suite B, 707 Highway 66 East, Tijeras, NM, 87059, US

(73) Assignee: Andreas Stihl AG & Co., KG, Waiblingen (DE)

(21) Appl. No.: 10/782,416

(22) Filed: Feb. 18, 2004

(30) Foreign Application Priority Data
Mar. 6, 2003 (DE) 03 09 732.5

(51) Int. Cl. B01D 50/00; B01D 59/50

(52) U.S. Cl. 123/198 E; 55/485

(57) ABSTRACT

An intake air filter for an internal combustion engine is provided. The intake air filter has at least one main filter, at least one fine filter, and a circumferential sealing member that is formed on the main filter. The fine filter is fixedly connected with the sealing member.

### BACKGROUND OF THE INVENTION

The present invention relates to an intake air filter for an internal combustion engine, especially in a manually-guided implement such as a cut-off machine or the like.

U.S. Pat. No. 5,582,146 discloses an intake air filter for an internal combustion engine, and includes a main filter as well as a fine filter. The main filter has a circumferential sealing rim in which the fine filter is held via its sealing rim. To clean or replace the filters, they must be individually removed from the housing.

It is an object of the present invention to provide an intake air filter of the aforementioned general type that is easy to handle.

### BRIEF DESCRIPTION OF THE DRAWINGS

This object, and other objects and advantages of the present invention, will appear more clearly from the following specification in conjunction with the accompanying schematic drawings, in which:

FIG. 1 is a longitudinal cross-sectional view through one exemplary embodiment of an inventive intake air filter;

FIG. 2 is an enlarged cross-sectional view of the sealing member of the main filter; and

FIG. 3 is an exploded view of the main filter and of the fine filter.

### SUMMARY OF THE INVENTION

The object of the present application is realized by an intake air filter that comprises at least one main filter, at least one fine filter, and a circumferential sealing member that is formed on the main filter, wherein the fine filter is fixedly connected with the sealing member.

As a consequence of the fixed connection of the fine or auxiliary filter and the main filter, the number of parts that have to be handled during replacement or cleaning of the filters is reduced. In particular, there is ensured that one cannot forget to put the fine filter back in the housing after the replacement or cleaning. Due to the fact that only a single sealing member is provided for the main filter and the fine filter, assembly is simplified.

The sealing member advantageously comprises foam material, especially polyurethane. An easy manufacturing ability is achieved if the rim of the fine filter is molded into the sealing member, especially being foamed in. This simultaneously provides a simple, secure and non-detachable connection between the fine filter and the main filter. The fine filter is expediently spaced from the main filter in the direction of flow. During operation of the intake air filter, the fine filter can become wet due to spit-back from the intake channel. The spacing between the fine filter and the main filter can ensure that the main filter does not become wet. The main filter is, in particular, a lamellar or sheet filter of filter paper that is folded in a lamellar manner. The main filter has an essentially quadratic configuration, whereby the shortest edge is disposed parallel to the direction of flow. In this way, it is possible to achieve a high throughput of air with a small overall size. The fine filter is expediently flat, and has a rectangular or right-angled shape.

The sealing member of the intake air filter advantageously rests against a housing of the air filter, and separates a clean chamber, that is connected with the intake channel of the engine, from a dirty chamber from which air is drawn. To ensure a straightforward and easy cleaning or replaceability of the intake air filter, the housing is formed from at least two housing parts that are interconnected in the region of the sealing member. To achieve a reliable, dependable seal relative to the atmosphere, the sealing member rests sealingly against both housing portions. In this way, by means of a single sealing member not only can the clean chamber be sealed relative to the dirty chamber, but the interior of the housing can also be sealed relative to the atmosphere.

Further specific features of the present application will be described in detail subsequently.

### DESCRIPTION OF SPECIFIC EMBODIMENTS

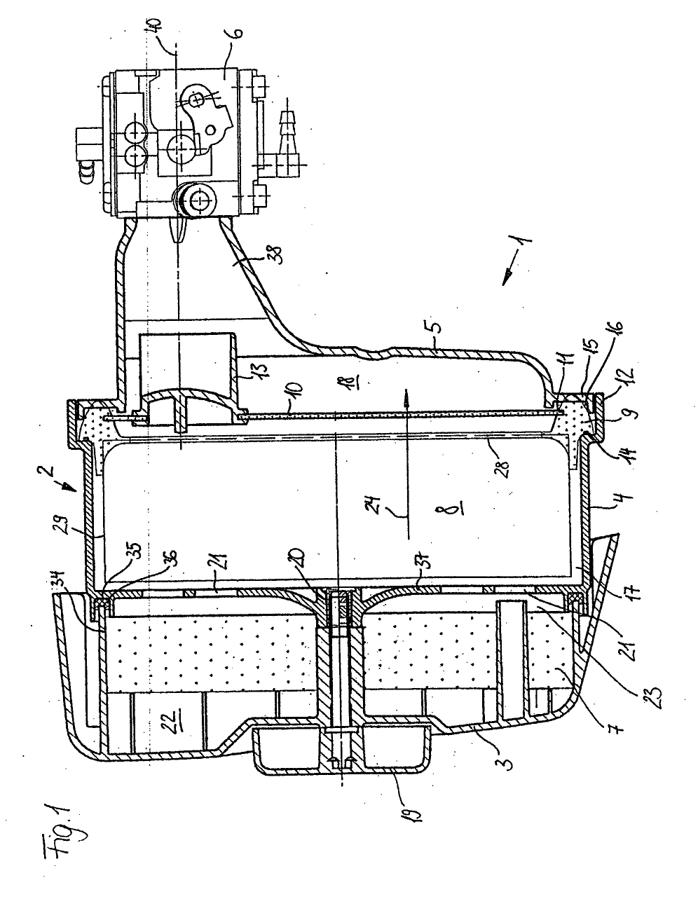

Referring now to the drawings in detail, the intake air filter 1 illustrated in FIG. 1 has a multi-part housing 2 in which are arranged a coarse or prefilter 7, a main filter 8, and a fine filter 10. The housing 2 includes a cover 3 into which the atmospheric air is drawn through non-illustrated air inlets, and in which is disposed the prefilter 7. The prefilter 7 separates the dirty chamber 22, which communicates with the atmosphere via the air inlets, from a clean chamber 23 of the prefilter 7. The prefilter 7 can, for example, comprise foam material or the like.

The cover 3 has a rim or collar 34, which is disposed in a sealing groove 35 of a housing half shell 4. Disposed in the sealing groove 35 is a seal 36. In this way, the clean chamber 23 of the prefilter 7 is sealed relative to the atmosphere. On that side that faces the cover 3, the housing half shell 4 has a screw boss 20 in which the cover 3 is removably secured via a thumb or butterfly screw 19. The housing half shell 4 has openings 21 in the wall 37 that faces the prefilter 7; air drawn in from the clean chamber 23 of the prefilter 7 enters via the openings 21 into the dirty chamber 17 of a main filter 8 that is disposed in the housing half shell 4. The housing half shell 4 is closed off on that side that is remote from the cover 3 by a housing cover 5. Formed on the housing cover 5 is an intake channel portion 38 that leads to a carburetor 6 that is disposed downstream of the intake air filter 1.

The main filter 8 has a sealing member 9 that extends all the way around and that is circumferentially formed on the downstream side 28 of the main filter 8 perpendicular to the direction of flow 24. The sealing member 9 is held in the housing 2 in the vicinity of the plane of separation between the housing half shell 4 and the housing cover 5. In the vicinity of the plane of separation, the housing half shell 4 has a rim 12 that extends over a rim 15 on the housing cover 5. The rim 12 is connected via a step 14 with the main body of the housing half shell 4. The sealing member 9 of the main filter 8 rests against the step 14. The rim 15 of the housing cover 5 is embodied as a recess 16. The sealing member 9 also abuts in the recess 16, so that by means of the sealing member 9, the atmosphere is sealed off relative to the interior of the housing 2.

The fine filter 10 is disposed downstream of the main filter 8, as viewed in the direction of flow 24. At its rim 11, the fine filter 10 is formed into the sealing member 9, and is thereby fixedly connected with the main filter 8. Held in the extension of the longitudinal axis 40 of the intake channel, in the fine filter 10, is a spit cup 13 that traps fuel spit back from the carburetor 6 and thus prevents residue or soot from forming in the fine filter 10. The sealing member 9 separates the dirty chamber 17, which is formed upstream of the main filter 8, from the clean chamber 18, which is formed downstream of the fine filter 10.

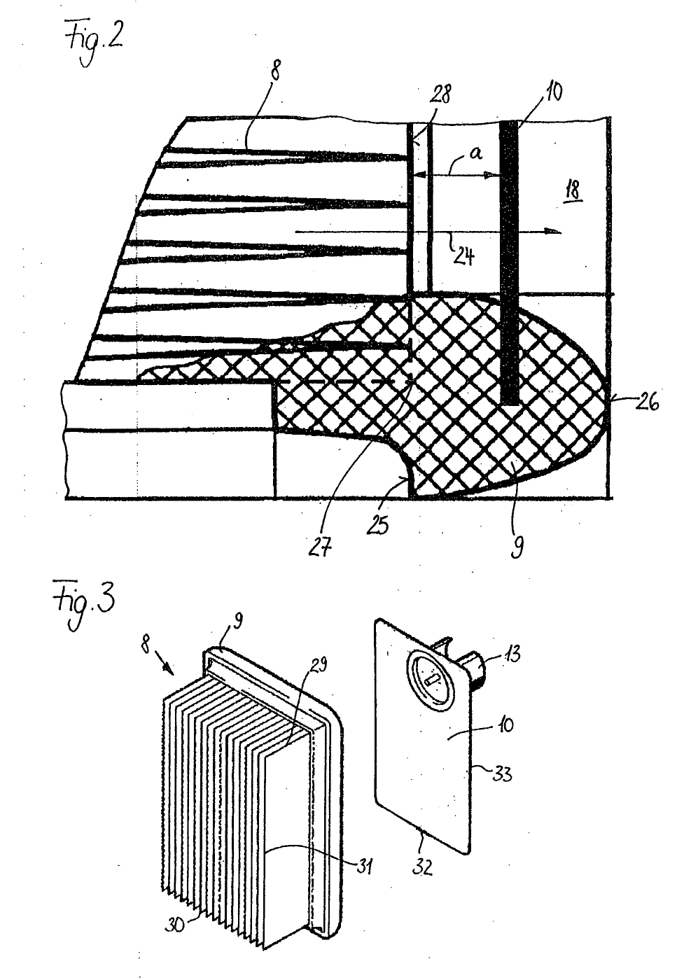

Illustrated in an enlarged view in FIG. 2 is a portion of the sealing member 9 with the main filter 8 and the fine filter 10. The sealing member 9 extends in the region of the circumferential edge 27 of the main filter 8, which edge delimits the side 28 of the main filter 8. The sealing member 9 has a circumferential abutment surface 25 with which it rests against the step 14 of the housing half shell 4. The abutment surface 25 is disposed approximately at the level of the side 28 of the main filter 8. Downstream of the fine filter 10 the sealing member 9 has a further abutment surface 26 with which the sealing member 9 rests against the base of the groove or recess 16 of the housing cover 5. the fine filter 10 is fixedly held in the sealing member 9 at a spacing a relative to that side 28 of the main filter 8 that faces the fine filter 10.

FIG. 3 shows the main filter 8 and the fine filter 10 in an exploded view. The main filter 8 is a lamellar or sheet filter of filter paper that is folded in a lamellar manner. As schematically shown in FIG. 3, the main filter 8 has an approximately quadrilateral configuration, whereby the sheets extend parallel to the long edges 31 of the quadrangle. The central edges 30, which together with the long edges 31 form the sides that lie perpendicular to the direction of flow 24, are respectively delimited by the sheets of the folded filter paper. The short edges 29 of the main filter 8 are disposed parallel to the direction of flow 24. The fine filter 10 has a short side 32, the length of which corresponds approximately to the length of the central edge 30, and also has a long side 33, the length of which corresponds approximately to the length of the long edge 31. The fine filter 10 has a flat and rectangular configuration. When the fine filter 10 is molded in, the side 28 of the main filter 8 that is delimited by the edges 30 and 31 is disposed parallel to the plane formed by the fine filter 10. The sealing member 9 has outer edges that are larger than the outer edges of the main filter 8, so that the sealing member 9 extends beyond the main filter 8 at the housing wall, and the main filter 8 is spaced from the housing wall.

The sealing member 9 is expediently comprised of a foam material, especially polyurethane.

The specification incorporates by reference the disclosure of German priority document 103 09 732.5 filed Mar. 6, 2003.

The present invention is, of course, in no way restricted to the specific disclosure of the specification and drawings, but also encompasses any modifications within the scope of the appended claims.

1. An intake air filter for an internal combustion engine, comprising:
at least one main filter;
at least one fine filter; and
a circumferential sealing member formed on said main filter, wherein said fine filter is fixedly connected with said sealing member.

2. An intake air filter according to claim 1, wherein said sealing member is made of foam material.

3. An intake air filter according to claim 2, wherein said foam material is polyurethane.

4. An intake air filter according to claim 1, wherein said fine filter is provided with a rim, and wherein said rim is molded into said sealing member.

5. An intake air filter according to claim 4, wherein said rim of said fine filter is foamed into said sealing member.

6. An intake air filter according to claim 4, wherein said fine filter is spaced from said main filter in a direction of flow of air through said intake air filter.

7. An intake air filter according to claim 1, wherein said main filter is a lamellar filter.

8. An intake air filter according to claim 1, wherein said main filter has an essentially quadratic configuration, wherein a shortest edge thereof is disposed parallel to a direction of flow of air through said intake air filter.

9. An intake air filter according to claim 1, wherein said fine filter is flat and has a rectangular shape.

10. An intake air filter according to claim 1, which further includes a housing, wherein said sealing member rests against said housing and separates a clean chamber which is in communication with an intake channel of the engine, from a dirty chamber from which air is drawn.

11. An intake air filter according to claim 10, wherein said housing is formed of at least two housing portions that are interconnected in a vicinity of said sealing member, and wherein said sealing member rests sealingly against said housing portions.
